(19) United States
(12) Patent Application Publication
(10) Pub. No.: US 2012/0176452 A1
(43) Pub. Date: Jul. 12, 2012

(54) METHOD FOR REFILLING INK INTO INK CARTRIDGE AND FILLING TOOL

(75) Inventor: LEI QIN, Guangdong (CN)

(73) Assignee: ZHUHAI NINESTAR MANAGEMENT CO., LTD., Guangdong (CN)

(21) Appl. No.: 13/005,477

(22) Filed: Jan. 12, 2011

(51) Int. Cl. B41J 2/175

(52) U.S. Cl. 347/85

(57) ABSTRACT

A method for refilling ink into ink cartridge comprises: I. hermetically connecting an ink injection port of the ink cartridge to an ink supply port of an ink storage container of an ink filling tool which is not completely filled with ink, connecting a suction unit to the ink storage container of the ink filling tool and sealing the ink cartridge; II. sucking out the air inside the ink storage container of the ink filling tool by the suction unit; III. releasing the suction unit so that the ink inside the ink storage container of the ink filling tool is automatically absorbed by the ink cartridge due to atmospheric pressure balance. An ink filling tool used in the method described above also is provided.

### FIELD OF THE INVENTION

The invention relates to a method for refilling ink into ink cartridge and a filling tool.

### BACKGROUND OF THE INVENTION

Printing device, such as ink jet printer and the like, prints by jetting liquid ink onto printing medium. Printing device, especially household small printing device, prints by storing ink in an ink cartridge and then continuously supplying the ink from the ink cartridge to a printing head. However, since the device must be minimized in size, even taking full consideration of the frequency of using the printer, the ink cartridge (as shown FIG. 1) is still designed to have small volume; therefore its capacity is also limited. Therefore, frequent replacement of the ink cartridge or frequent refill of ink supply to the ink cartridge is required.

In terms of the effective utilization of resources, refill of ink to the ink cartridge without the replacement of the ink cartridge is preferable. However, in practice, ordinary consumers directly inject the ink with an injector when refilling the ink into the ink cartridge, which could result in that the amount of the ink injected into negative pressure material goes beyond its absorption capacity due to erroneous operation. In this case, the pressure inside the ink cartridge is larger than external atmospheric pressure, thus failures such as the overflow of the ink from an ink supply port to an ink jet port are likely to occur in use. Therefore, a negative pressure ink injection method is invented. Various negative pressure ink injection methods usually form a negative pressure inside the ink cartridge by directly sucking the air inside the ink cartridge, and the ink is pressed into the ink cartridge by atmospheric pressure. As a result, the defect of generating positive pressure inside the ink cartridge is solved. However, residual ink inside the ink cartridge is often sucked out in this way, which causes ink waste and environmental pollution. And clothes of the user can be stained accidently by the ink.

### SUMMARY

One aspect of the present invention provides a method for refilling ink into an ink cartridge, in order to solve the technical problem that conventional methods for refilling the ink into an ink cartridge could suck out the residual ink inside the ink cartridge and cause ink waste and environmental pollution.

In order to solve the above technical problem, the technical solution adopted by an embodiment of the present invention is as below:

A method for refilling ink into an ink cartridge comprises the following steps:

I. Opening an ink injection port of the ink cartridge, hermetically connecting the ink injection port to an ink supply port of an ink storage container of an ink filling tool, connecting a suction unit to the ink storage container of the ink filling tool, and sealing the ink cartridge;

II. Sucking out the air inside the ink storage container of the ink filling tool by the suction unit;

III. Releasing the suction unit so that the ink inside the ink storage container of the ink filling tool is automatically absorbed by the ink cartridge due to atmospheric pressure balance.

After step III is completed, the following step is performed: removing the ink cartridge from the ink filling tool and sealing the ink injection port by a rubber plug.

Another aspect of the present invention also provides an ink filling tool used in the method described above:

An ink filling tool used in the above method comprises an ink storage container and an ink supply pipe capable of being connected with the ink injection port of the ink cartridge, wherein the ink storage container is provided with an ink supply port connected with the ink supply pipe. The ink filling tool further comprises a suction unit, wherein the ink supply port is arranged at an upper part of the ink storage container, the ink supply pipe extends from the ink supply port to bottom of the ink storage container, the upper part of the ink storage container is further provided with a suction port, through which the suction unit is hermetically connected with the ink storage container.

The ink filling tool further comprises a fixing component for fixing the ink cartridge.

The ink filling tool further comprises a positioning component for positioning the ink filling tool.

The ink filling tool further comprises an ink outlet sealing member for sealing the ink cartridge.

According to the technical solution described above, the air inside the ink cartridge is firstly absorbed by means of the principal of atmospheric pressure, and then the air-absorbing pressure is removed so that the ink inside the ink storage container is pressed into the ink cartridge by means of the principal of atmospheric pressure balance. In this way, there is no need to suck out the residual ink inside the ink cartridge and the entire process is also implemented under a sealing state, thereby solving the technical problem that the current methods for refilling the ink into ink cartridge could suck out the residual ink inside the ink cartridge and cause ink waste and environmental pollution.

### BRIEF DESCRIPTION OF THE DRAWINGS

FIG. 1 is a schematic diagram of a conventional ink cartridge.

FIG. 2 is a schematic diagram of filling ink into an ink cartridge by using the ink filling tool according to an embodiment of the invention.

FIG. 3 is an exploded view of the ink filling tool according to an embodiment of the invention.

FIG. 4 is a schematic diagram showing that filling ink into an ink cartridge is started by using the ink filling tool according to an embodiment of the invention.

FIG. 5 is a schematic diagram of filling ink into an ink cartridge by using the ink filling tool according to an embodiment of the invention.

FIG. 6 is a schematic diagram showing that filling ink in an ink cartridge is completed by using the ink filling tool according to an embodiment of the invention.

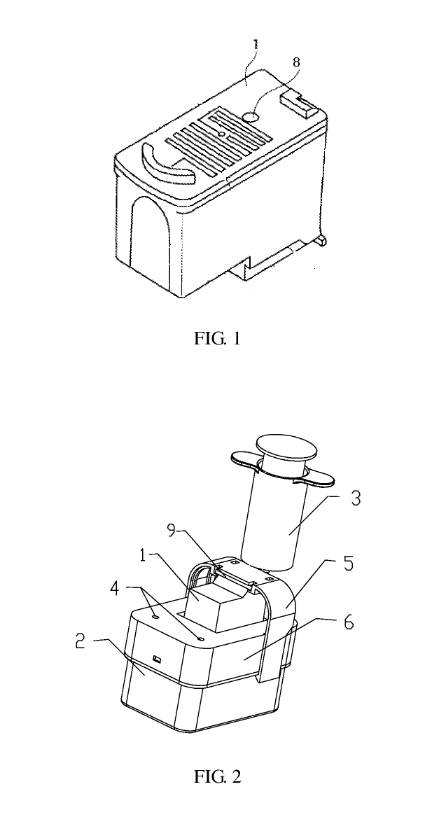

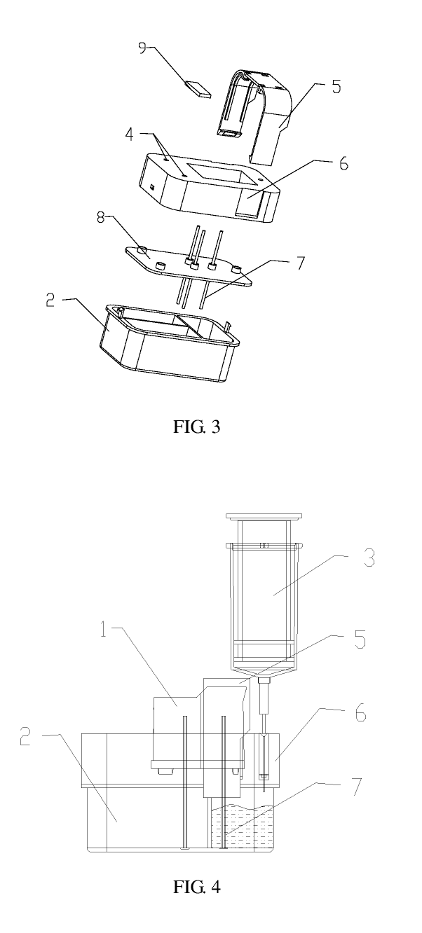

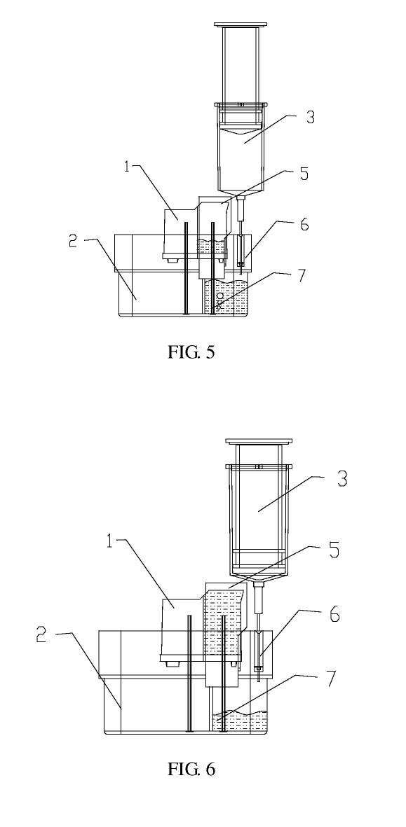

In the Figures, 1 ink cartridge 2 ink storage container 3 suction unit 4 suction port 5 fixing component 6 positioning component 7 ink supply pipe 8 sealing component 9 ink outlet sealing member

### DETAILED DESCRIPTION

A method for refilling ink into an ink cartridge comprises the following steps:

I. hermetically connecting an ink injection port of the ink cartridge to an ink supply port of an ink storage container of an ink filling tool which is not completely filled with ink, wherein the ink injected into the ink storage container of the ink filling tool reaches the maximal scale of the container (about ⅔ of the full capacity of the ink storage container), connecting a suction unit to the ink storage container of the ink filling tool and sealing the ink cartridge;

II. Sucking out the air inside the ink storage container of the ink filling tool by the suction unit, and by means of the principal of the atmospheric pressure balance in airtight containers, the air inside the ink cartridge can flows towards the ink storage container through the ink supply pipe;

III. Releasing the suction unit and the ink inside the ink storage container of the ink filling tool is automatically absorbed by the ink cartridge due to atmospheric pressure balance.

IV. Removing the ink cartridge from the ink filling tool and sealing the ink injection port with a rubber plug. The ink cartridge can be reused.

The ink filling tool used in the method described above comprises an ink storage container 2 with a sealing component 8, an ink supply pipe 7 being connected with the ink injection port of an ink cartridge 1, a fixing component 5 for fixing the ink cartridge 1, a sealing member 9 for fixing an ink outlet of the ink cartridge, and a positioning component 6 for positioning the ink cartridge 1 and a suction unit 3, wherein the ink storage container 2 is provided with an ink supply port connected with the ink supply pipe 7, the ink supply port is arranged at an upper part of the ink storage container 2, the ink supply pipe 7 extends from the ink supply port to the bottom of the ink storage container 2; the upper part of the ink storage container 2 is provided with suction ports 4, through which the suction unit 3 is hermetically connected with the ink storage container 2.

The present invention has the advantages that: printing cost can be lowered by utilizing the residual ink inside the cartridge. Ink is filled hermetically by way of negative pressure automatic absorption, which is convenient and rapid, so as to facilitate user's operation.

What is claimed is:

1. A method for refilling ink into an ink cartridge, comprising:
I. opening an ink injection port of the ink cartridge, hermetically connecting the ink injection port to an ink supply port of an ink storage container of an ink filling tool, connecting a suction unit to the ink storage container of the ink filling tool, and sealing the ink cartridge;
II. sucking out air inside the ink storage container of the ink filling tool by the suction unit; and
III. releasing the suction unit so that ink inside the ink storage container of the ink filling tool is automatically absorbed by the ink cartridge due to atmospheric pressure balance.

2. The method for refilling ink into an ink cartridge according to claim 1, after the step III is completed, further comprising: removing the ink cartridge from the ink filling tool and sealing the ink injection port by a rubber plug.

3. An ink filling tool used in the method according to claim 1, comprising an ink storage container and an ink supply pipe capable of being connected with the ink injection port of the ink cartridge, wherein the ink storage container is provided with an ink supply port connected with the ink supply pipe, the ink filling tool further comprises a suction unit, wherein the ink supply port is arranged at an upper part of the ink storage container, the ink supply pipe extends from the ink supply port to bottom of the ink storage container, the upper part of the ink storage container is further provided with a suction port, through which the suction unit is hermetically connected with the ink storage container.

4. The ink filling tool according to claim 3, further comprising a fixing component for fixing the ink cartridge.

5. The ink filling tool according to claim 3, further comprising a positioning component for positioning the ink cartridge.

6. The ink filling tool according to claim 3, further comprising an ink outlet sealing member for sealing the ink cartridge.
